(19) United States
(12) Patent Application Publication
(10) Pub. No.: US 2002/0106455 A1
(43) Pub. Date: Aug. 8, 2002

(54) Method of at least partly coating backing materials

(76) Inventors: Klaus Keite-Telgenbuscher, Hamburg (DE); Peter Jauchen, Hamburg (DE); Michael Zschaeck, Munchen (DE)

Correspondence Address: Norris, McLaughlin & Marcus, 30th Floor, 220 East 42nd Street, New York, NY, 10017, US

(21) Appl. No.: 09/902,055

(22) Filed: Jul. 10, 2001

(30) Foreign Application Priority Data
Aug. 16, 2000 (DE) 100 39 884.7

(51) Int. Cl. B05D 3/12

(52) U.S. Cl. 427/355

(57) ABSTRACT

Method of applying liquid or pastelike substances, especially thermoplastics, to a backing material, the substance being applied by means of a die at least partly to the backing material traveling along on the die, wherein

the die body is bent transversely to the direction of travel of the backing material and

the bending is induced by temperature differences within the die body.

The invention relates to a method of applying liquid or pastelike substances, especially thermoplastics, to a backing material, in which the substance is applied by means of a die at least partly to the backing material traveling beneath the die.

On the market, in the medical sector, for example, there are substrates which are coated with viscous substances. One means of implementing this coating is to use knife-coating methods which are open to the ambient environment and do not involve an applicator die. In many cases, this coating takes place over the full area by means of a coating die which is set against a backing roll around which is passed the web-form backing material for coating. In this case, the substance to be applied by coating is conveyed under pressure from the exit orifice of the die and placed on the web that is traveling past.

For the coating of backing materials intended for subsequent medical, cosmetic or industrial use, it is preferred to employ adhesive compositions, with particular preference self-adhesive compositions. The classes of material to which these compositions belong are preferably those of solutions, dispersions, prepolymers, and thermoplastic polymers.

Advantageously, use is made of thermoplastic hot-melt adhesive compositions based on natural and synthetic rubbers and on other synthetic polymers such as, for example, acrylates, methacrylates, polyurethanes, polyolefins, polyvinyl derivatives, polyesters or silicones with appropriate additives such as tackifier resins, plasticizers, stabilizers, and other auxiliaries, where necessary.

Their softening point should be higher than 50° C.; the application temperature is generally at least 60° C., preferably between 100° C. and 180° C., or between 180° C. and 220° C. in the case of silicones.

An aim here is to keep the amount of the substance applied to the web as constant as possible across the web width. This is fundamentally achieved by means of the rheological design of the flow channels in the die. Typical geometries here include, for example, the coat hanger manifold or axially extending manifold which have a greater cross-sectional area than the channels which channels radially from them and clearly branch off continue in the direction of the exit orifice. A drawback is that the rheological design is valid only for a limited viscosity range of the substance to be applied by coating. Any deviation from that range results in irregularities in the applied amount across the web width.

In order to prevent this or to expand the useful viscosity range of the dies thus designed, a variety of additional measures are taken. One known measure is to insert a restrictor bar in the outflow orifice of the die, said bar being adjustable in its height and hence in its restrictor effect. Adjustment is via a multiplicity of actuators arranged at regular intervals along the restrictor bar and often numbering up to 30 per meter of coating width. Actuators used comprise mainly screws, thermal bolts or piezo elements.

Alternatively, or in many cases also additionally, to the restrictor bar, the exit orifice is produced with an adjustable cross section. For this purpose, generally one lip of the orifice is forced into the desired position by an elastic deformation brought about by means of actuators as already mentioned above. Here again, the adaptation of the equal distribution is achieved by way of a very large number of actuators.

Further of significance for the uniformity of application of the substance is the gap between die and backing roll. This gap is adjusted by means of a mobile or swivelable die. The adjustment may usually be performed right and left of the web, independently of one another.

Sectional variation of the gap between die head and backing roll is also known for the purpose of compensating for errors in the amount applied across the width. For this purpose, the lip situated behind the exit orifice in the rotary direction of the backing roll is generally provided with a strip which is deformable or displaceable radially to the backing roll. Mention may also be made here of the customary multiplicity of the abovementioned actuators.

Also known are mechanical deformation means for the entire die body means. In this case, the parameter utilized is the change in path, which is in the μm range, between the middle and the edges of a steel body. In general, a mechanical displacement is brought about by means of spring force, differential thread positioning, etc., and a counterplate. The deformation travel that results from this is a controlled variable which in the case of 100% polymers is directly proportional to the coating application.

Additionally, use is made of segmented coating dies, in which each segment has a separate incoming flow of substance and a separate adjustment means for the amount of substance supplied. The latter is realized by means of individual metering pumps or valves per segment. Segmented adjustment of the exit amount produces homogeneity in the amount applied across the coating width.

Disadvantages of all of the above-described means of influencing the equal distribution of the amount applied across the web width are the comparatively high constructional and mechanical engineering complexity and, as a result of the multiplicity of the actuators, the lengthiness and low level of reproducibility of adjustment of the equal distribution.

Also known is the construction of an automatic control circuit for adjusting and maintaining an equal distribution of the amount applied. In this case, in the course of coating, the amount applied is determined by means, for example, of beta emitters at as many measuring sites as there are actuators, and, in the case of deviations from the preset value, an actuating signal is output to the actuator in question. In this case, the actuators used are preferably thermal bolts and piezo elements. Disadvantages are the enormously high mechanical engineering and measurement and control engineering complexity, and the financial expense, which such a system necessitates.

Another known means of evening out the flow of substance across the width is the integration into the die body itself of a delivery pump which extends over the entire die length. Delivery pumps employed in this case include gear pumps and sliding vane rotary pumps.

Here again, the high level of mechanical engineering complexity is a drawback.

From certain viewpoints, it is sensible for the coatings not to have closed surfaces but instead to be applied in the form of dots, thereby making it possible, for example, for the skin under bandages not to macerate, owing to the possibility for sweat and other skin excretions to escape. A suitable method of achieving this dot-form coating is that of rotary screen printing. Halftone printing and the inkjet principle are further methods.

In the case of rotary screen printing, the inside of a rotating screen houses a nozzle via which, from the outside, the fluid to be applied by coating is introduced into the screen compartment and is pressed through the screen perforations in the direction of the substrate to be coated. The screen is lifted from the substrate in accordance with the rate of transportation of the substrate (rotary speed of the screen drum). As a consequence of the adhesion and internal cohesion of the fluid, the supply of fluid confined in the perforations is removed in sharp definition by the base of the domes that is already adhering to the backing or is conveyed onto the backing by means of the prevailing pressure.

After the end of this transportation, the more or less highly curved surface of the dome forms over the given base area, as a function of the rheology of the fluid. The height-to-base ratio of the dome depends on the ratio of the perforation diameter to the wall thickness of the screen drum and on the physical properties (flow behavior, surface tension, and contact angle on the backing material) of the fluid.

The implementation of the method is described fundamentally in CH 648 497 A5; improvements are described in EP 0 288 541 A1, EP 0 565 133 A1, EP 0 384 278 A1, DE 42 31 743 A1 and U.S. Pat. No. 5,626,673.

Advance metering dies for rotary screen printing are similar in their construction principle to the coating dies for full-area coatings. Unlike them, however, the constructional space here is greatly restricted, since the die has to find room inside the screen cylinder, which generally has a diameter of only at least 20 cm. Die designs are likewise elucidated in the documents mentioned above. The left and right adjustment independently of one another, of the gap with respect to the sieve or to the backing roll, is generally present. Since the sieve takes on a certain post-metering function and thus contributes to homogenizing the amount applied across the web width, there are generally no further actuators for homogenization.

The absence of measures for homogenization becomes a problem, however, in the case of screens having a large open area (>30% passage), since in this case the post-metering function becomes less and less effective, especially when operating at high fluid pressure.

Only in a few cases is the exit orifice given a sectionally adjustable cross section design or is a restrictor bar used. To date, use has been made in this case only of adjusting screws, which makes adjustment in the course of ongoing screen printing operation impossible. Also described is the integration of a gear pump extending over the entire die length (EP 0 288 541 A1).

A key aspect which has not been taken into account to date in the design of screen printing dies is the sagging of the die owing to its own weight or owing to intentional measures.

A reason for the failure to take this into account is that the die length has to date rarely been more than about 50 cm. However, the implementation of screen printing dies with a length of more than one meter, mounted only at their ends as dictated by the process, means that the sagging owing to the low moment of inertia of this die construction form can no longer be disregarded. A difference in the gap with respect to the backing roll of just 0.01 mm results—in the case of sieves having a high open area (for example, 50%)—in a fluctuation in the amount applied of approximately 5 g/m².

It is an object of the invention to provide a method which is outstandingly suited to applying viscous liquids at an identical application rate across the entire width of the backing material by means of a die whose body is bent and which avoids the disadvantages known from the prior art.

This object is achieved by a method as described in the main claim. The dependent claims relate to advantageous developments of the subject matter of the invention.

The invention accordingly provides a method of applying liquid or pastelike substances, especially thermoplastics, to a backing material, the substance being applied by means of a die at least partly to the backing material traveling along on the die, wherein

the die body is bent transversely to the direction of travel of the backing material and

the bending is induced by temperature differences within the die body.

The inventive solution of a coating method and the corresponding die design avoid the abovementioned disadvantages and weaknesses. Consistent application of the substance across the entire width of the backing material is ensured.

In one preferred embodiment, the die body is temperature-controlled differently in its cross section in two zones which are disposed along its longitudinal axis, so as to give a simple line of curvature without inflection points.

In a further advantageous design, a bending line with at least one inflection point is produced by additional segmentation of the zones of different temperature control in the longitudinal direction of the die into at least three differently temperature-controlled zones.

The temperature control of the zones may be achieved by heating or cooling. Accordingly, heat transfer fluids or cooling fluids, which are guided in channels in accordance with the zone division, or electrical heating elements may be used. However, Peltier elements, radiation heating or convection heating systems are also suitable.

In one particular design, the fluid to be applied by coating is itself used as temperature-control medium for at least one zone.

It is further preferred for the backing material to be guided along an apparatus which produces counterpressure, in particular a roll.

Applying the substance by means of the die through a perforated cylinder onto the backing material (rotary screen printing process) represents a further outstanding variant of the method.

A particularly advantageous feature with this variant is that the bending of the die by a change in temperature control may also be adjusted in the course of an ongoing rotary screen printing operation, with the die able to be given a compact construction and the mechanical engineering complexity being comparatively small.

Preferably it is possible to utilize both the bending in the radial direction with respect to the backing roll and also the bending perpendicular thereto. In the first case, influence is exerted directly on the size of the gap between die and backing roll; in the second case, the gap remains constant in its perpendicular projection but the actual dimension is influenced by the displacement of the die lip being tangential to the backing roll.

The method may also be utilized without the use of a counterpressure-producing apparatus; in this case, the die is bent perpendicularly to the direction of travel of the backing material.

In one preferred embodiment, the die may be moved and/or swiveled in its mounts, i.e., may be moved or swiveled right and left of the web, independently of one another.

Surprisingly, these few controlled variables are sufficient to achieve uniform application of composition across the width of the coating web; many instances of unequal distribution occur symmetrically, such as the sagging of the die under its own weight, the cross-sectional thickening of the backing roll owing to thermal expansion or else flow-induced effects owing to non-ideal rheological design of the die.

The construction of an automatic control circuit for adjusting and maintaining equal distribution of the amount applied may also be advantageous in the case of the method described. In this case, in the course of ongoing coating, the amount applied is determined at just a few measurement sites by means, for example, of beta emitters or infrared thermometers and, in the case of deviations from the preset value, an actuating signal is output to the corresponding temperature-control device.

The method described may be used with advantage to coat liquids having a dynamic viscosity of from 0.1 up to 1000 Pa.s, preferably from 1 to 500 Pa.s (measured at 175° C. (DIN 53 018, Brookfield DV II, spindle 21)).

Substances suitable for application include all organic and inorganic compounds whose viscosity may be brought into the abovementioned range by means of an increase in temperature, including dispersions, emulsions, solutions, and melts. For the coating of backing materials intended for subsequent medical, cosmetic or industrial use, it is preferred to employ adhesive compositions, with particular preference self-adhesive compositions. The classes of material to which these compositions belong are preferably those of solutions, dispersions, prepolymers, and thermoplastic polymers.

Advantageously, use is made of thermoplastic hot-melt adhesive compositions based on natural and synthetic rubbers and on other synthetic polymers such as, for example, acrylates, methacrylates, polyurethanes, polyolefins, polyvinyl derivatives, polyesters or silicones with corresponding additives such as fillers, tackifier resins, plasticizers, stabilizers, and other auxiliaries, where necessary.

Their softening point should be higher than 50° C., since the application temperature is generally at least 60° C., preferably between 100° C. and 180° C., or between 180° C. and 220° C. in the case of silicones. If desired, subsequent crosslinking by means of UV or electron beam exposure may be appropriate in order to establish particularly advantageous properties in the hot-melt adhesive compositions.

Hot-melt adhesive compositions based on block copolymers, in particular, are notable for their diverse variation options, since the targeted reduction in the glass transition temperature of the self-adhesive composition as a result of the selection of the tackifiers, plasticizers, polymer molecule size and molecular weight distribution of the starting components ensures the required bonding to the skin in a manner appropriate to their function, even at critical points of the human locomotor system.

For systems which adhere particularly strongly, the hot-melt adhesive composition is based preferably on block copolymers, especially A-B or A-B-A block copolymers or blends thereof. The hard phase A is principally polystyrene or its derivatives, and the soft phase B comprises ethylene, propylene, butylene, butadiene, isoprene or blends thereof, particular preference being given here to ethylene and butylene or their blends.

However, polystyrene blocks may also be present in the soft phase B, specifically in an amount of up to 20% by weight. The overall styrene content should nevertheless always be lower than 35% by weight. Preference is given to styrene contents of between 5% and 30%, since a lower styrene content makes the adhesive composition more conforming.

The targeted blending of diblock and triblock copolymers is particularly advantageous, preference being given to a diblock copolymer content of less than 80% by weight.

In one advantageous embodiment, the hot-melt adhesive composition is composed as follows:

| | |
|---|---|
| from 10 to 90% by weight | block copolymers, |
| from 5 to 80% by weight | tackifiers such as oils, waxes, resins |
| | and/or mixtures thereof, preferably |
| | mixtures of resins and oils, |
| less than 60% by weight | plasticizers |
| less than 15% by weight | additives, |
| less than 5% by weight | stabilizers. |

The aliphatic or aromatic oils, waxes and resins used as tackifiers are preferably hydrocarbon oils, hydrocarbon waxes and hydrocarbon resins; the consistency of the oils, such as paraffinic hydrocarbon oils, or of the waxes, such as paraffinic hydrocarbon waxes, accounts for their favorable effect on skin bonding. Plasticizers used include medium- or long-chain fatty acids and/or their esters. These additions serve to adjust the adhesion properties and the stability. If desired, further stabilizers and other auxiliaries are employed.

Filling the adhesive composition with mineral fillers, fibers or hollow or solid microbeads is possible.

Medical backing materials in particular are subject to stringent requirements in terms of the adhesion properties. For ideal application, the hot-melt adhesive composition should possess a high tack. There should be functionally appropriate bond strength to the skin and to the reverse face of the backing. So that there is no slipping, moreover, the hot-melt adhesive composition is required to have a high shear strength. The targeted reduction in the glass transition temperature of the adhesive composition as a consequence of the selection of the tackifiers, the plasticizers, the polymer molecule size and the molecular distribution of the starting components achieves the required functionally appropriate bonding to the skin and to the reverse face of the backing. The high shear strength of the adhesive composition is achieved through the high cohesiveness of the block copolymer. The good tack is a result of the range of resins, tackifiers, and plasticizers that is employed.

The properties of the product such as tack, glass transition temperature, and shear stability may be quantified effectively using a dynamomechanical frequency measurement. Use is made here of a rheometer controlled by shearing stress. The results of this measurement method give information on the physical properties of a substance by taking into account the viscoelastic component. In this instance, at a specified temperature, the hot-melt adhesive composition is set in oscillation between two plane-parallel plates with variable frequencies and low deformation (linear viscoelastic region). Via a pickup control unit, with computer assistance, the quotient (Q=tan δ) between the loss modulus (G″, viscous component) and the storage modulus (G′, elastic component) is found.

Q=tan δ=G″/G′

A high frequency is chosen for the subjective sensing of the tack, and a low frequency for the shear strength. A high numerical value denotes better tack and poorer shear stability.

The glass transition temperature is the temperature at which amorphous or partially crystalline polymers undergo transition from the liquid or rubber-elastic state into the hard-elastic or glassy state, or vice versa (Römpp Chemie-Lexikon, 9th ed., volume 2, page 1587, Georg Thieme Verlag Stuttgart—New York, 1990). It corresponds to the maximum of the temperature function at a specified frequency. For medical applications in particular, a relatively low glass transition point is required.

| | T_{g} | Conformability | Tack |
|---|---|---|---|
| Designation | low frequency | low frequency/RT | high frequency/RT |
| Hot-melt | −12 ± 2° C. | tan δ = 0.32 ± 0.03 | tan δ = 1.84 ± 0.03 |
| adhesive | | | |
| composition | | | |
| A | | | |
| Hot-melt | −9 ± 2° C. | tan δ = 0.22 ± 0.03 | tan δ = 1.00 ± 0.03 |
| adhesive | | | |
| composition | | | |
| B | | | |

The hot-melt adhesive compositions are preferably formulated such that their dynamic-complex glass transition temperature at a frequency of 0.1 rad/s is less than 15° C., preferably from 5° C. to −30° C., with very particular preference from −3° C. to −15° C.

In accordance with the invention, preference is given to hot-melt adhesive compositions for which the ratio of the viscous component to the elastic component at a frequency of 100 rad/s at 25° C. is greater than 0.7, in particular between 1.0 and 5.0, or to hot-melt adhesive compositions for which the ratio of the viscous component to the elastic component at a frequency of 0.1 rad/s at 25° C. is less than 0.6, preferably between 0.4 and 0.02, with very particular preference between 0.35 and 0.1.

In the case of partial coating, the domes or polygeometric structural forms may have different shapes. Flattened hemispheres are preferred. Furthermore, printed application of other shapes and patterns on the backing material is also possible—for example, a printed image in the form of alphanumeric character combinations, or patterns such as grids, stripes, assemblies of domes, and zigzag lines.

The adhesive composition may be distributed uniformly on the backing material; however, it may also be applied with a thickness or density which varies over the area, as appropriate for the function of the product.

Suitable backing materials include all rigid and elastic sheetlike structures composed of synthetic and natural raw materials. Preference is given to backing materials which following the application of the adhesive composition may be used in such a way that they fulfil the technical requirements or properties of a functionally appropriate bandage. Examples are textiles such as wovens, knits, lays, nonwovens, laminates, nets, films, foams, and papers. In addition, these materials may be pretreated and/or aftertreated. Common pretreatments are corona and hydrophobicization; customary aftertreatments are calendering, thermal conditioning, laminating, punching, and enveloping.

The backing material, especially when coated directly, must have a certain strength and density in order to prevent the domes, during the coating operation, from penetrating too far into the backing material or even striking right through to its other side.

In one preferred embodiment of the method of the invention, the domes and/or polygeometric structural forms are transferred to a second backing material after the coating operation. In this case, the second backing material represents the actual backing, with the first backing material acting as an auxiliary backing. An auxiliary backing of this kind may also be implemented in the form of an abhesively coated roll or belt.

A preferred embodiment of the auxiliary backing is the roll with an abhesive surface, it being possible for the abhesive roll surface to comprise silicone or fluorine compounds or plasma-coated release systems. These may be applied in the form of a coating having a weight per unit area of from 0.001 g/m² to 3 000 g/m², preferably from 100 to 2 000 g/m².

For the implementation of the method, it is desirable for the abhesive surface of the roll to be adjustable in temperature between 0° C. and 200° C., preferably less than 60° C., with particular preference less than 25° C. It is particularly advantageous in this context if the abhesive properties of the surface of the roll are tailored in such a way that the applied self-adhesive composition adheres even to a cooled roll (<25° C.).

Subsequent calendering of the coated product and/or pretreatment of the backing, such as corona irradiation, may also be advantageous for better anchoring of the adhesive film.

In addition, treatment of the hot-melt adhesive composition by electron beam postcross-linking or by UV irradiation may result in an improvement in the desired adhesion properties.

The backing material is coated preferably at a speed of more than 2 m/min, more preferably from 20 to 200 m/min.

The partial application makes it possible to dissipate the transepidermal water loss through regulated channels and improves the evaporation from the skin by sweating, especially when the backing materials used are permeable to air and water vapor. This prevents skin irritations brought about by accumulation of body fluids. The dissipation channels set up enable fluids to be conducted away, even when a multi-ply dressing is being used.

The use of breathable coatings in conjunction with elastic and likewise breathable backing materials results in a degree of wear comfort which is perceived by the user to be subjectively pleasant.

In one preferred embodiment of the method of the invention, the backing material thus coated has an air permeability of more than 1 cm³/(cm²·s), preferably from 10 to 150 cm³/(cm²·s), and/or a water vapor permeability of more than 200 g/(m²·24 h), preferably from 500 to 5 000 g/(m²·24 h).

In another preferred embodiment of the method of the invention, the backing material thus coated possesses, on steel, a bond strength to the reverse face of the backing of at least 0.5 N/cm, particularly a bond strength of between 2 N/cm and 20 N/cm.

In a further advantageous embodiment, the self-adhesive compositions are foamed before being applied to the backing material.

In this case, the self-adhesive compositions are foamed preferably using inert gases such as nitrogen, carbon dioxide, noble gases, hydrocarbons or air, or mixtures thereof. In many cases, foaming additionally by thermal decomposition of gas-evolving substances, such as azo, carbonate and hydrazide compounds, has proven suitable.

The degree of foaming, i.e., the gas content, should be at least about 5% by volume and may reach up to about 85% by volume. In practice, values of from 10% by volume to 75% by volume, preferably 50% by volume, have been found to be satisfactory. Operating at relatively high temperatures of approximately 100° C. and a comparatively high internal pressure produces very open-pored adhesive foam layers which are particularly permeable to air and water vapor.

The advantageous properties of the foamed self-adhesive coatings, such as low consumption of adhesive, high tack and good conformability, even on uneven surfaces, owing to the elasticity and plasticity, and also the initial tack, may be utilized to best effect very particularly in the field of medical products.

A particularly suitable method of producing the foamed self-adhesive composition operates in accordance with the foam mixing system. Here, the thermoplastic self-adhesive composition is reacted under high pressure with the gases provided, such as nitrogen, air or carbon dioxide, for example, in different volume proportions (from about 10% by volume to 80% by volume) in a stator/rotor system and at a temperature above the softening point.

While the gas entry pressure is greater than 100 bar, the mixing pressures between gas and thermoplastic in the system are from 40 to 100 bar, preferably from 40 to 70 bar. The pressure-sensitive adhesive foam produced in this way may subsequently be passed through a line into the coating die.

By virtue of the foaming of the self-adhesive composition and of the open pores in the composition which are produced as a result, and given the use of an inherently porous backing, the products coated with the adhesive composition possess good water vapor and air permeability. The amount of adhesive composition required is considerably reduced without any adverse effect on the adhesion properties. The adhesive compositions have a surprisingly high tack, since per gram of composition there is more volume and thus more adhesion surface available for wetting of the substrate that is to be bonded, and the plasticity of the adhesive compositions is increased as a result of the foam structure. Anchoring on the backing material is also improved in this way. The foamed adhesive coating, moreover, as has already been mentioned above, gives the products a soft and smooth feel.

Foaming also reduces the viscosity, in general, of the adhesive compositions. This lowers the melt energy, and even thermally unstable backing materials can be coated directly.

The outstanding properties of the self-adhesively treated backing material of the invention suggests its use for medical products, especially plasters, medical fixings, wound coverings, doped systems, especially those which release substances, and orthopedic or phlebological bandages and dressings.

Finally, following the coating operation, the backing material may be enveloped in an anti-adhesive backing material, such as siliconized paper, or may be provided with a wound pad or padding.

It is particularly advantageous if the backing material can be sterilized, preferably by means of gamma radiation. Consequently, particular suitability for subsequent sterilization is possessed by block-copolymer-based hot-melt adhesive compositions which contain no double bonds. This applies in particular to styrene-butylene-ethylene-styrene block copolymers or styrene-butylene-styrene block copolymers. In this case, the adhesive properties are not subject to any changes significant for the application.

The backing material is also outstandingly suitable for industrial reversible fixings which on removal cause no damage or injury to a variety of substrates, such as paper, plastics, glass, textiles, wood, metals or minerals.

Finally, it is possible to produce technically permanent bonds which can be separated only with partial splitting of the substrate.

An advantageous embodiment of the subject matter of the invention will be illustrated by a number of figures and an example, without wishing thereby unnecessarily to restrict the invention.

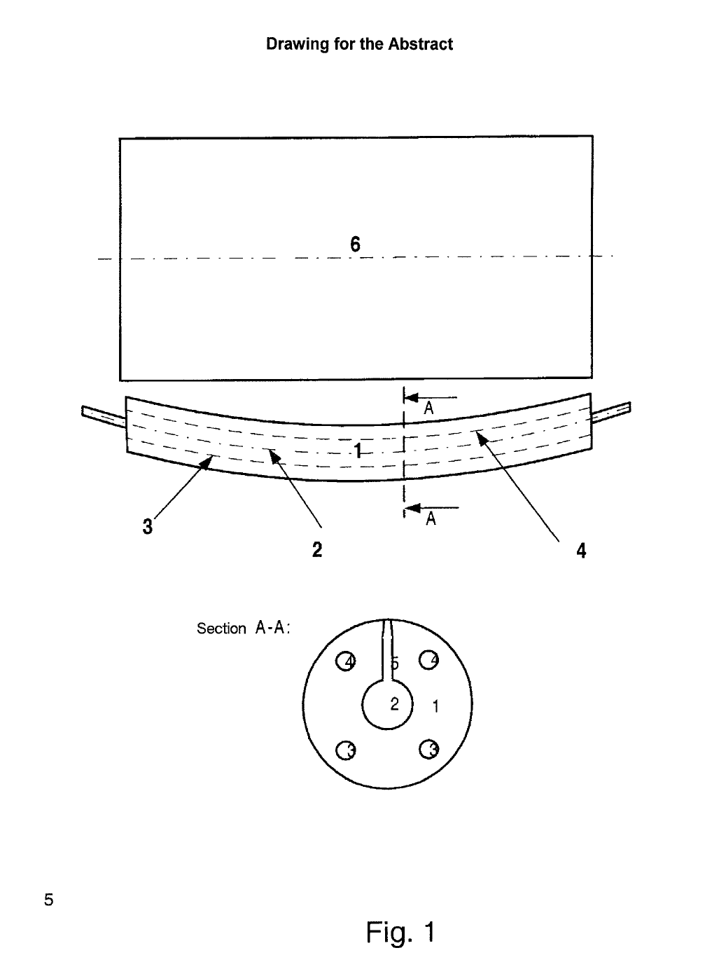

FIG. 1 shows a section of a coating unit operating in accordance with the method of the invention, with the die bent radially with respect to the backing roll,

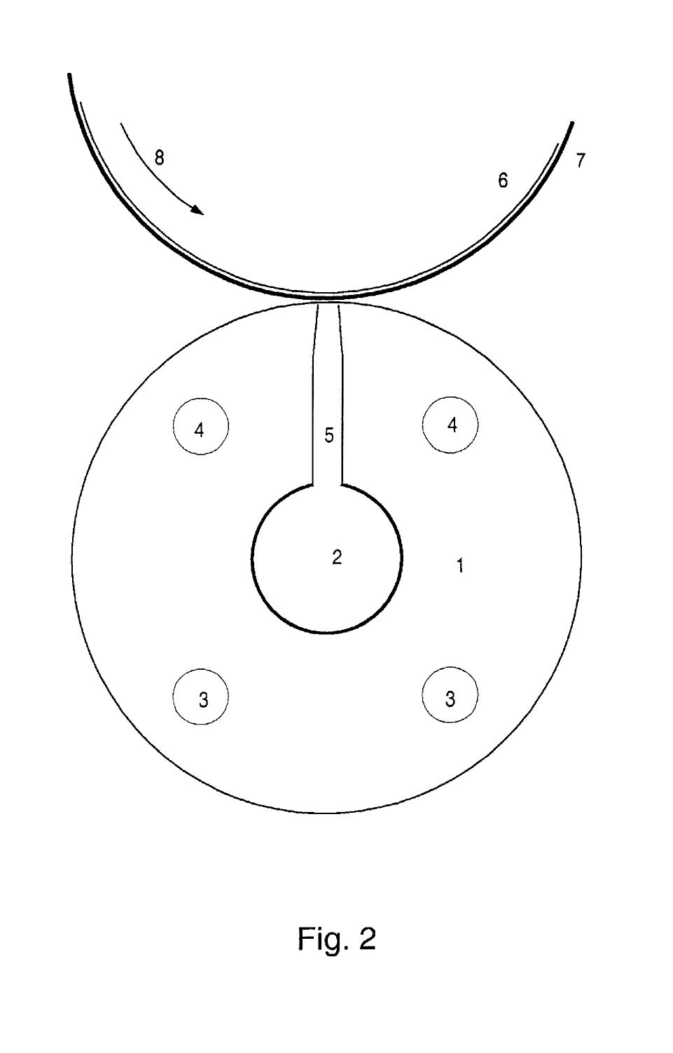

FIG. 2 shows a cross section through the die,

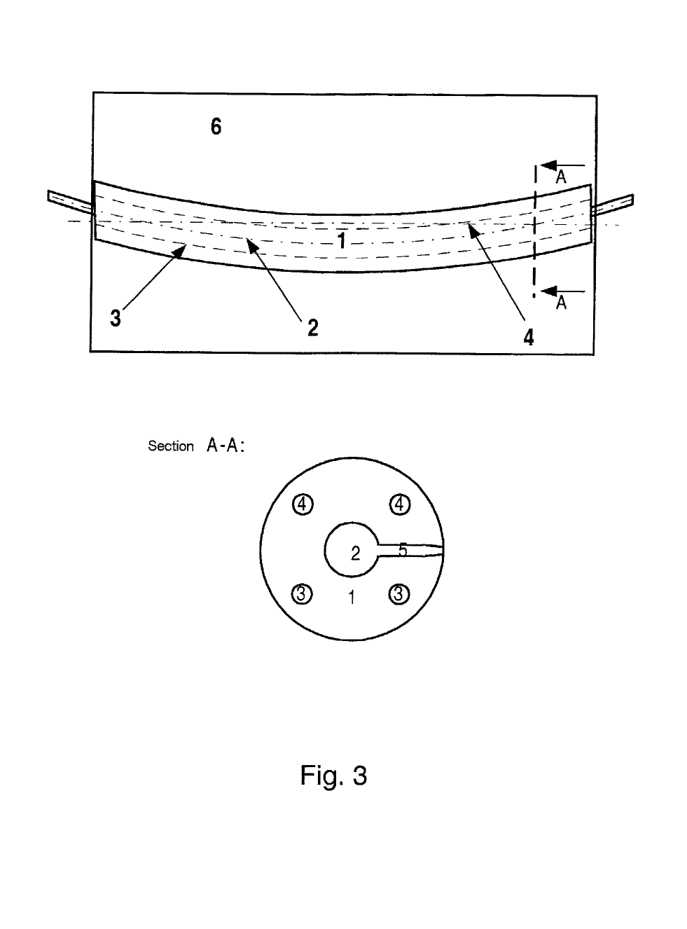

FIG. 3 shows a section of a coating unit operating in accordance with the method of the invention, with the die bent perpendicularly to the radius of the backing roll, and

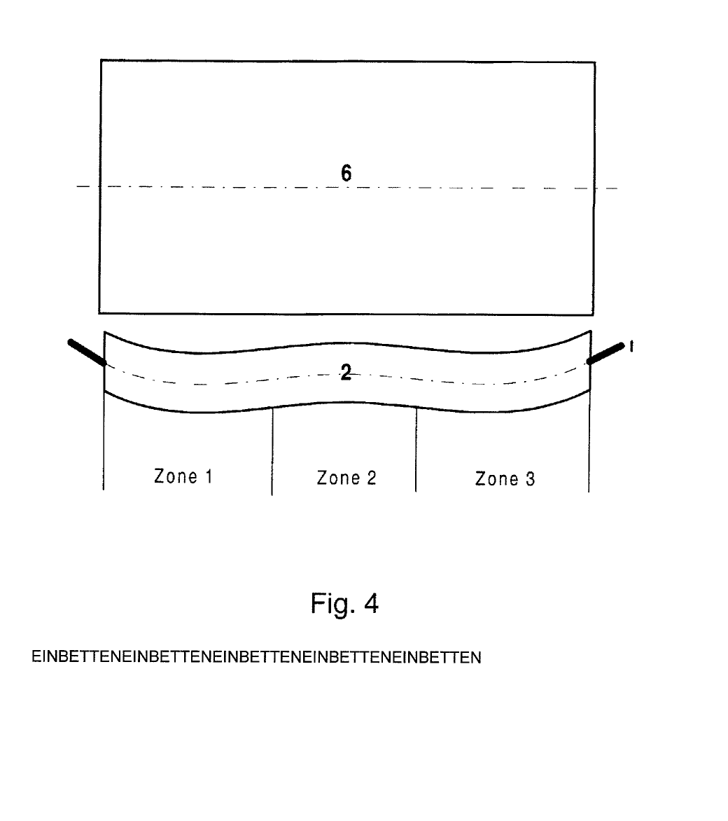

FIG. 4 shows a section of a coating unit operating in accordance with the method of the invention, with the die bent radially to the backing roll in a plurality of zones along the longitudinal axis of the die, giving a bending line having two inflection points.

FIG. 1 shows a section of a coating unit operating in accordance with the method of the invention, with the die 1 bent radially with respect to the backing roll 6. The temperature in the zone of the die body that is heated by the temperature-control elements 3 is higher than in the zone heated by the temperature-control elements 4. The section A-A shows the position of the exit orifice 5.

FIG. 2 shows a cross section. The backing material 7 is guided into a gap between the die 1 and the backing roll 6 (rotational direction 8). The backing material 7 is coated with a fluid by the exit orifice 5 of the die. The fluid flows through a manifold pipe 2 situated axially in the die's base body 1 via the exit orifice 5 to the point of coating.

The die's base body is heated by temperature-control elements 3 and 4 which, in order to produce the bending, generate different temperature levels in the top and bottom of the die's basic body.

FIG. 3 shows a section of a coating unit operating in accordance with the method of the invention, with the die 1 bent perpendicularly to the radius of the backing roll. The temperature in the zone of the die body that is heated by the temperature-control elements 3 is higher than in the zone heated by the temperature-control elements 4. The section A-A shows the position of the exit orifice 5.

FIG. 4 shows a section of a coating unit operating in the method of the invention, accordance with the die bent radially with respect to the backing roll in a plurality of zones along the longitudinal axis of the die. In zones 1 and 3 the temperature in the lower region of the die body is higher than in the upper region, while in zone 2 the temperature in the upper region is higher than in the lower region. This results in a bending line having two inflection points.

### EXAMPLE

In a rotary screen printing machine with a coating width of 1 m, equipped with the customary devices for guiding a continuous web, such as unwinder, rewinder, web edge control and web tension measuring systems, and with its coating section comprising a rotating cylindrical screen, a die located within the screen at its 12 o'clock position, and a backing roll which presses the screen against the coating die, a thermoplastic adhesive is coated onto a paper web.

Processing temperature in feed system and die 120° C.

Processing temperature in screen perforation region 120° C.

Basis weight of the paper web 65 g/m²

Screen 14 mesh, perforation size 0.9 mm

Die heating is as follows:

2 electric heating rods in the base body of the die above the central manifold pipe Power: 12 kW

2 electric heating rods in the base body of the die below the central manifold pipe Power: 12 kW

The top and bottom electric heating rods may be set at different temperatures.

At the sides, the die is mounted on swivel arms which are moved against stops by means of which it is possible to set the distance between die and backing roll and also screen, on the right- and left-hand sides independently of one another.

The width of the die exit orifice is constant.

There is no active temperature control of the backing roll.

Using this apparatus, an application rate of 130 g/m² was achieved. In order to make the amount of composition applied uniform transversely to the web, the lower die heater was set 15° C. higher than the upper die heater. The standard deviation of the amount of composition applied transversely to the web was then 1.7 g/m².

What is claimed is:

1. A method of applying liquid or pastelike substances, especially thermoplastics, to a backing material, the substance being applied by means of a die at least partly to the backing material traveling along on the die, wherein
the die body is bent transversely to the direction of travel of the backing material and
the bending is induced by temperature differences within the die body.

2. The method as claimed in claim 1, wherein the die has at least two zones temperature-controlled differently in its cross section and/or along its longitudinal axis.

3. The method as claimed in either of claims 1 and 2, wherein the die body is temperature-controlled using a heat transfer fluid or cooling fluid, electrical heaters, Peltier elements, radiation or convection.

4. The method as claimed in any of claims 1 to 3, wherein the coating fluid is itself used for temperature control of at least one of the zones.

5. The method as claimed in any of claims 1 to 4, wherein the die in its mounts may be moved and/or swiveled.

6. The method as claimed in any of claims 1 to 5, wherein the bending occurs substantially perpendicularly to the backing material or substantially in or against the direction of travel of the backing material.

7. The method as claimed in any of claims 1 to 6, wherein the backing material is guided along an apparatus which produces counterpressure, in particular a roll.

8. The method as claimed in one or more of the preceding claims, wherein the substance is applied by means of the die through a perforated cylinder onto the backing material.

9. The method as claimed in one or more of the preceding claims, wherein the bending of the die is controlled as a function of the amount of the substance that is applied, determined on the traveling web.

10. The method as claimed in one or more of the preceding claims, wherein the substance at the processing shear has a dynamic zero temperature viscosity of from 0.1 Pa.s to 1 000 Pa.s, preferably from 1 Pa.s to 500 Pa.s.

11. The method as claimed in one or more of the preceding claims, wherein the substance is a solution, dispersion, prepolymer or thermoplastic polymer, preferably a hot-melt adhesive, with particular preference a hot-melt pressure-sensitive adhesive.

12. The method as claimed in one or more of the preceding claims, wherein the backing material is a roll or belt having an abhesive surface, the abhesive surface comprising in particular a coating of silicone or fluorine compounds or plasma-coated release systems, applied very particularly at a weight per unit area of from 0.001 g/m² to 3 000 g/m², preferably from 100 to 2 000 g/m².
